(19) United States
(12) Patent Application Publication
(10) Pub. No.: US 2010/0120281 A1
(43) Pub. Date: May 13, 2010

(54) Card connector capable of detecting card insertion

(75) Inventor: Yaw-Huey Lai, Taipei County (TW)

Correspondence Address: BACON & THOMAS, PLLC, 625 SLATERS LANE, FOURTH FLOOR, ALEXANDRIA, VA, 22314-1176, US

(73) Assignee: TAI-SOL ELECTRONICS CO., LTD., TAIPEI CITY (TW)

(21) Appl. No.: 12/320,377

(22) Filed: Jan. 26, 2009

(30) Foreign Application Priority Data
Nov. 7, 2008 (TW) 97220025

(51) Int. Cl. H01R 4/50

(52) U.S. Cl. 439/346

(57) ABSTRACT

A card connector capable of detecting card insertion includes a base frame, a cover member, and a plurality of terminals. The base frame is made of an insulated material. The cover member is made of electrically conductive material and is mounted onto the base frame, whereby a card chamber is formed between the cover member and the base frame. The terminals are mounted onto the base frame, extending into the card chamber. Among the terminals, a detectable terminal is insert-molded in the base frame and located at one side of the base frame. The detectable terminal includes a contact portion exposed outside. The cover member includes a tongue extending toward the detectable terminal therefrom. The tongue has a working portion extending into the card chamber and a touch portion corresponding to the contact portion. Therefore, the card connector is of convenient assembly to lessen the assembly time and the labor cost.

### BACKGROUND OF THE INVENTION

1. Field of the Invention

The present invention relates generally to card connectors, and more particularly, to a card connector capable of detecting card insertion.

2. Description of the Related Art

A conventional card connector as disclosed by Taiwan Patent No. M326727 is detectable while an electronic card is inserted therein. The card connector includes two conductive pieces mounted to an insulated main body therein and located at one side of a card chamber. When the card is inserted into the card connector, one of the conductive pieces is pushed by the card to touch the other conductive piece for electric conduction and then a signal is generated by the electric conduction to detect whether the card is inserted or not.

It is necessary for the conventional card connector to install the two conductive pieces onto the insulated main body, such that the insulated main body must have corresponding ditches for receiving the conductive pieces. However, such design needs longer assembly time to take more labor.

### SUMMARY OF THE INVENTION

The primary objective of the present invention is to provide a card connector, which is capable of detecting card insertion and of convenient assembly to shorten the assembly time and to lower the labor cost.

The foregoing objective of the present invention is attained by the card connector composed of a base frame, a cover member, and a plurality of terminals. The base frame is made of an insulated material. The cover member is made of electrically conductive material and is mounted onto the base frame, whereby a card chamber is formed between the cover member and the base frame and respective front ends of the base frame and the cover member jointly define an entrance. The terminals are mounted onto the base frame, extending into the card chamber. Among the terminals, a detectable terminal is insert-molded in the base frame and located at one side of the base frame. The detectable terminal includes a contact portion exposed outside. The cover member includes a standing sidewall extending downward from what corresponds to one side of the detectable terminal. The standing sidewall has a tongue extending toward the detectable terminal therefrom. The tongue has a working portion extending into the card chamber and a touch portion corresponding to the contact portion.

### BRIEF DESCRIPTION OF THE DRAWINGS

FIG. 1 is a perspective view of a preferred embodiment of the present invention.

FIG. 2 is a perspective view of a part of the preferred embodiment of the present invention.

FIG. 3 is an exploded view of a part of the preferred embodiment of the present invention.

FIG. 4 is a perspective view of another part of the preferred embodiment of the present invention.

FIG. 5 is another perspective view of a part of the preferred embodiment of the present invention.

FIG. 6 is a schematic view of the preferred embodiment of the present invention.

FIG. 7 a schematic view of the preferred embodiment of the present invention having an inserted card therein.

FIG. 8 is an enlarged view taken from A indicated in FIG. 7.

### DETAILED DESCRIPTION OF PREFERRED EMBODIMENTS

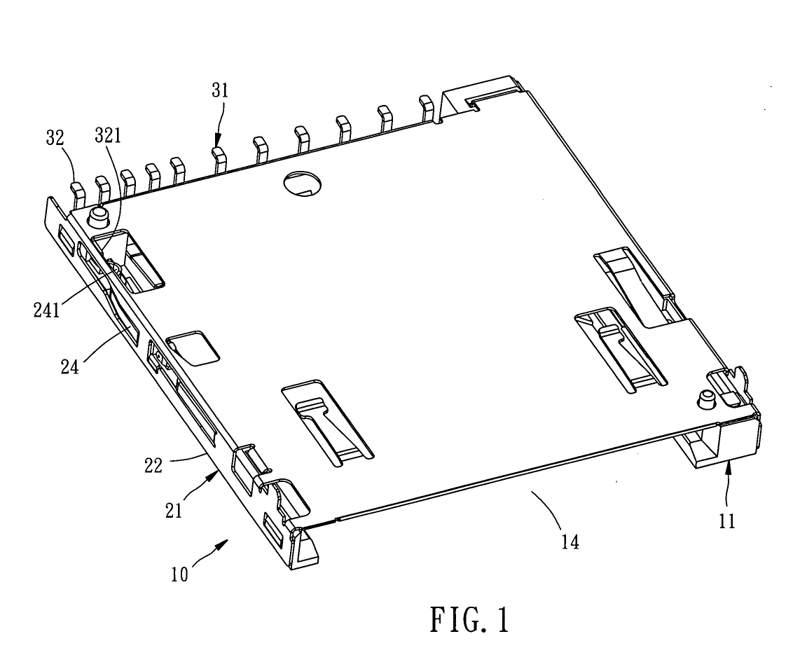

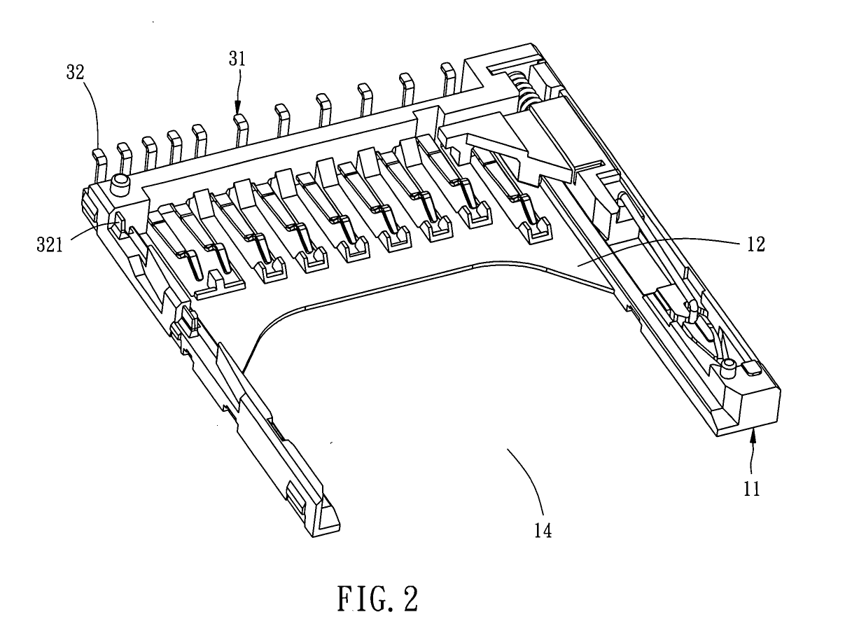

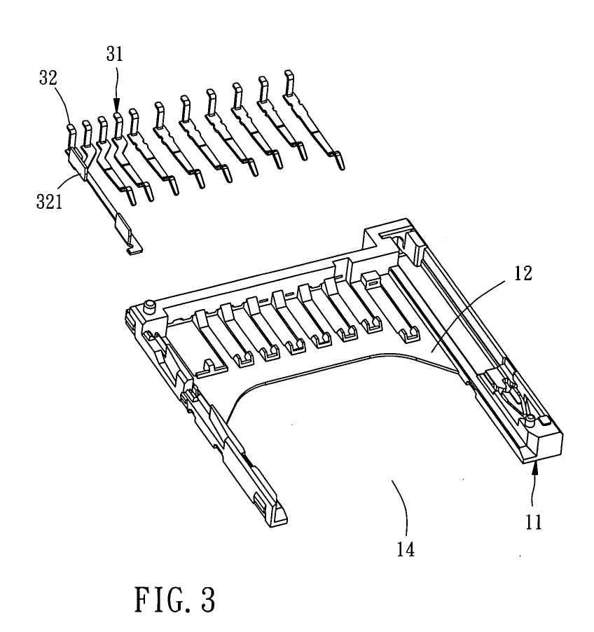

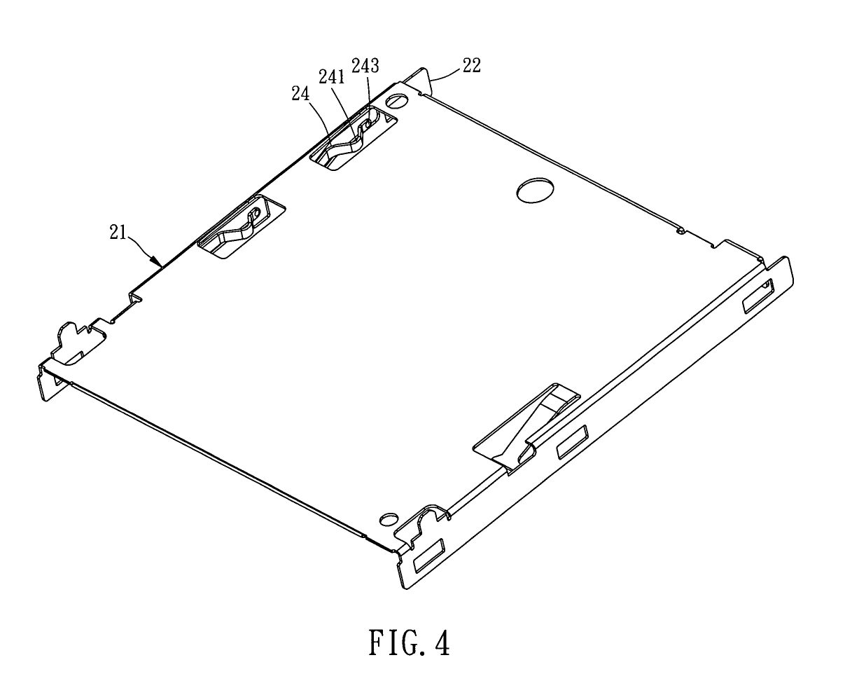

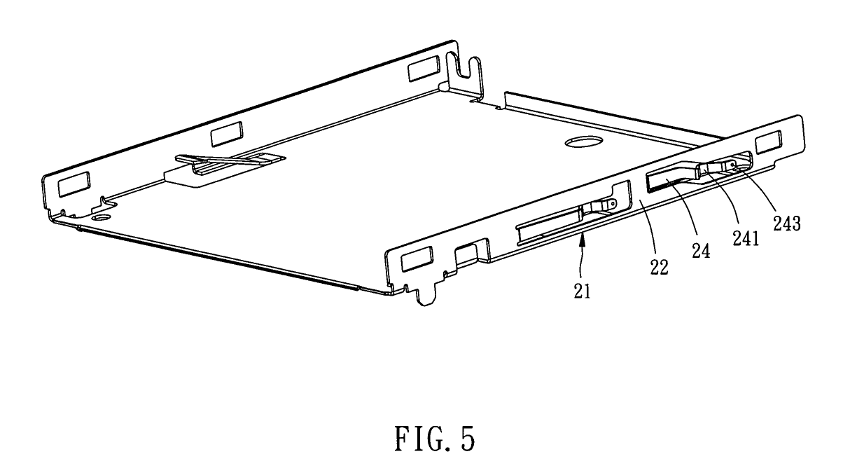

Referring to FIGS. 1-5, a card connector 10 capable of detecting card insertion as constructed according to a preferred embodiment of the present invention is composed a base frame 11, a cover member 21, and a plurality of terminals 31.

The base frame 11 is made of an insulated material, which is plastic in this embodiment.

The cover member 21 is made of an electrically conductive material, which is a metal in this embodiment, and is covered on the base frame 11. A card chamber 12 is formed between the base frame 11 and the cover member 21. Front ends of the base frame 11 and the cover member 21 jointly define an entrance 14 respectively.

The terminals 31 are mounted onto the base frame 11, extending into the card chamber 12. One of the terminals 31 is a detectable terminal 32. The detectable terminal 32 is insert-molded in the base frame 11 and located at one side of the base frame 11, extending forward from a rear end of the base frame 11, having a part exposed outside to define a contact portion 321. The contact portion 321 has a bottom edge partially embedded into the base frame 11.

The cover member 21 includes a standing sidewall 22 extending downward from one side thereof and corresponding to the detectable terminal 32. The standing sidewall 22 has a tongue 24 extending toward the detectable terminal 32, a V-shaped working portion 241 extending from the tongue 24, and a touch portion 243 corresponding to the contact portion 321. After the cover member 21 is mounted onto the base frame 11, the working portion 241 extends into the card chamber 12. In this embodiment, the touch portion 243 contacts the contact portion 321 for normal close therebetween.

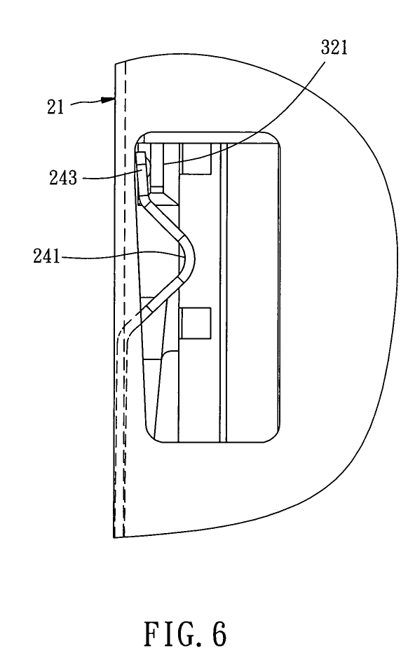

Referring to FIG. 6, when none of any electronic card is inserted into the card connector 10, the tongue 24 contacts the contact portion 321 by the touch portion 243 thereof for normal close. Under the circumstance of the normal close, it can be detected that the card has not been inserted into the card connector 10.

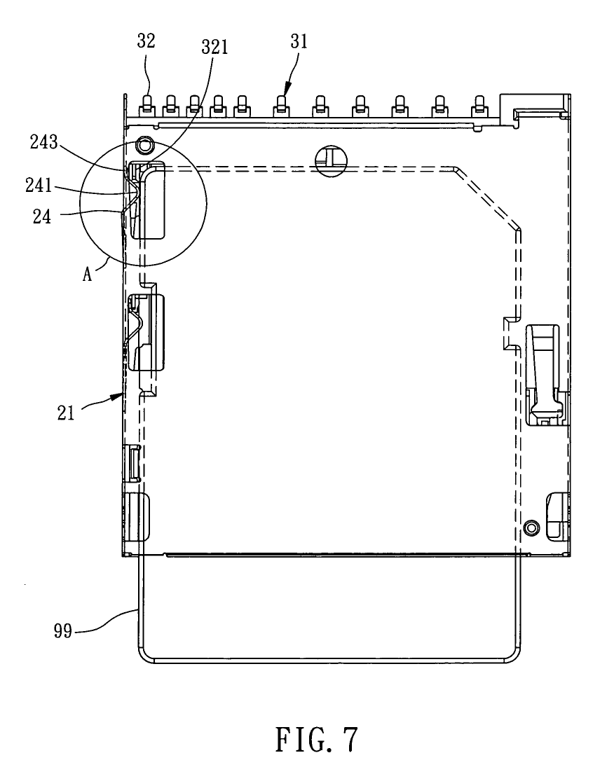

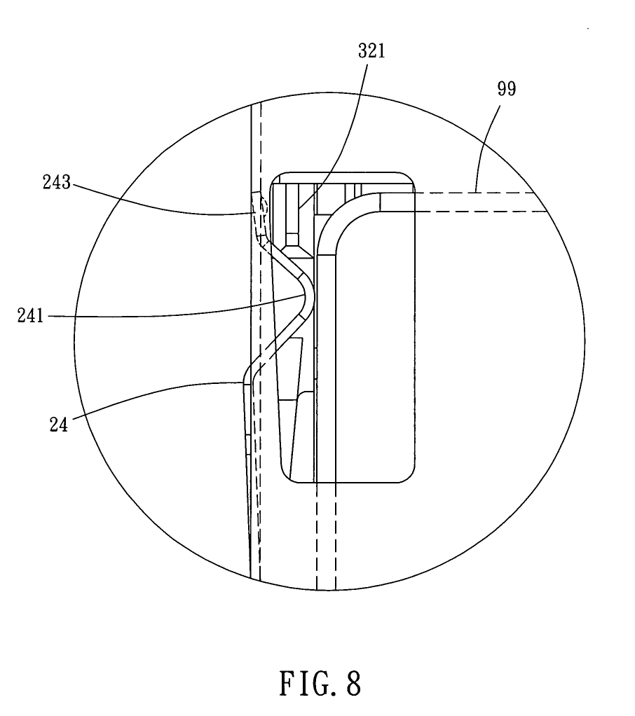

Referring to FIGS. 7 and 8, after an electronic card 99 is inserted through the entrance 99 and then into the card connector 10, the card 99 enters the card chamber 12 and an edge of the card 99 works on the working portion 241 to force the tongue to lean outward; meanwhile, the touch portion 243 is away from the contact portion 321 for normal open in such a way that it can be detected that the card 99 has been inserted into the card connector 10.

After the card 99 is extracted from the card connector 10, the card 99 has not worked on the working portion 241 any longer, such that the tongue 24 is repositioned to contact the detectable terminal 32 for the normal close again.

In addition, when the tongue 24 contacts the detectable terminal 32, the status of circuit can alternatively be normal open, and on the contrary, when the tongue 24 does not contact the detectable terminal 32, the status of circuit is normal close. In this way, it can still be detected whether the card 99 is inserted or not by two different statuses of circuit.

As known from above, the detectable terminal 32 is insert-molded in the base frame 11, such that the detectable terminal 32 is partially embedded inside the base frame 11 when the base frame 11 is formed. Besides, the tongue 24 is formed at the cover member 21, such that when the cover member 21 is mounted to the base frame 11, the detectable terminal 32 and the tongue 24 are set. Therefore, the present invention can do the convenient assembly to shorten the assembly time and lower the labor cost.

Although the present invention has been described with respect to a specific preferred embodiment thereof, it is no way limited to the details of the illustrated structures but changes and modifications may be made within the scope of the appended claims.

1. A card connector capable of card insertion, comprising:
a base frame made of an insulated material;
a cover member made of an electrically conductive material and mounted onto the base frame; a card chamber being formed between said base frame and said cover member, respective front ends of said cover member and said base frame jointly form an entrance; and
a plurality of terminals mounted to said base frame and extending into said card chamber, one of said terminals being a detectable terminal insert-molded in said base frame and located at a side of said base frame, said detectable terminal having a part exposed outside to define a contact portion;
wherein said cover member includes a tongue extending toward said card chamber and located beside said detectable terminal, said tongue having a working portion extending into said card chamber, said tongue having a touch portion corresponding to said contact portion.

2. The card connector as defined in claim 1, wherein said touch portion of said tongue contacts said contact portion.

3. The card connector as defined in claim 1, wherein said detectable terminal extends forward from a rear end of said base frame.

4. The card connector as defined in claim 1, wherein said contact portion has a bottom edge partially embedded in said base frame.

5. The card connector as defined in claim 1, wherein said working portion of said tongue is V-shaped and extends toward said card chamber.

6. The card connector as defined in claim 1, wherein said cover member comprises a standing sidewall downward from what corresponds to a side of said detectable terminal; said tongue extends toward said card chamber from said standing sidewall.
